(19) United States
(12) Patent Application Publication
(10) Pub. No.: US 2024/0406305 A1
(43) Pub. Date: Dec. 5, 2024

(54) USER TERMINAL

(71) Applicant: NTT DOCOMO, INC., Tokyo (JP)

(72) Inventors: Naoki YAMAMOTO, Chiyoda-ku (JP); Takashi HAMATANI, Chiyoda-ku (JP)

(73) Assignee: NTT DOCOMO, INC., Tokyo (JP)

(21) Appl. No.: 18/694,100

(22) PCT Filed: Sep. 28, 2022
(86) PCT No.: PCT/JP2022/036127

§ 371 Date: Mar. 21, 2024

(30) Foreign Application Priority Data
Sep. 28, 2021 (JP) 2021-157541

(51) Int. Cl. H04M 1/72463; G06F 3/04855; G06F 11/34

(52) U.S. Cl. CPC H04M 1/72463; G06F 3/04855; G06F 11/34

(57) ABSTRACT

A user terminal 10 of one embodiment is operated by a user. The user terminal 10 includes a usage amount acquisition unit 12 configured to acquire information indicating an amount of usage of the user terminal 10 by the user in a predetermined period, and a control unit 13 configured to reduce operability of the user terminal 10 when the amount of usage exceeds a predetermined threshold value.

### TECHNICAL FIELD

One aspect of the present invention relates to a user terminal.

### BACKGROUND ART

Patent Literature 1 discloses a system in which a usage time limit is set for each application installed on a user terminal (information terminal apparatus) and a warning message is displayed on a screen before a time of usage of the application reaches the usage time limit.

### CITATION LIST

### Patent Literature

[Patent Literature 1] Japanese Unexamined Patent Publication No. 2016-57845

### SUMMARY OF INVENTION

### Technical Problem

Recently, there has been a problem with the occurrence of physical or mental health impairment due to long-time use (overuse) of a user terminal. Specifically, in recent years, more people have been suffering from visual display terminals (VDT) syndrome such as fatigue of the eyes and stiffness of the shoulders due to long-time use of user terminals. For this reason, there is a demand for a system in which long-time use of user terminals can be effectively suppressed.

With the system disclosed in Patent Literature 1, a user can be prompted to stop use of an application by displaying a warning message. However, when only a warning message is provided (that is, in a configuration in which the use of the application can be continued even after the usage time limit is exceeded), the user can continue to use the application without regard to the warning message, resulting in an insufficient effect of suppressing the long-time use of the user terminal. On the other hand, when the use is limited strictly such that the application is forcibly terminated if the usage time of the application reaches the usage time limit, the application is forcibly terminated even when the user is under special situation that the user has to use the application beyond the usage time limit, resulting in greatly obstructing the user's work.

Accordingly, an object of an aspect of the present invention is to provide a user terminal capable of effectively suppressing long-time use of a user terminal without greatly obstructing a user's work.

### Solution to Problem

According to an aspect of the present invention, there is provided a user terminal that is operated by a user, the user terminal including a usage amount acquisition unit configured to acquire information indicating an amount of usage of the user terminal by the user in a predetermined period, and a control unit configured to reduce operability of the user terminal when the amount of usage exceeds a predetermined threshold value.

In the user terminal according to an aspect of the present invention, when the amount of usage of the user terminal exceeds the threshold value, the operability of the user terminal is controlled to be reduced. In this way, the user-friendliness of the user terminal is intentionally reduced as a penalty for the amount of usage beyond the threshold value, so that the user can be prompted to stop using the user terminal. On the other hand, even after the amount of usage exceeds the threshold value, the operability of the user terminal is reduced, but the use of the user terminal itself is not forcibly prohibited. Therefore, when the user is under special situation in which the user has to use the user terminal even after the amount of usage exceeds the threshold value, the user can continue to use the user terminal. In this way, with the above-described user terminal, it is possible to effectively suppress the long-time use of the user terminal without greatly obstructing the user's work.

### Advantageous Effects of Invention

According to an aspect of the present invention, it is possible to provide a user terminal capable of effectively suppressing long-time use of a user terminal without greatly obstructing a user's work.

### BRIEF DESCRIPTION OF DRAWINGS

FIG. 1 is a diagram illustrating an example of a functional configuration of a user terminal according to an embodiment.

FIG. 2 is a diagram illustrating a first example of operation control.

FIG. 3 is a diagram illustrating a second example of operation control.

FIG. 4 is a flowchart illustrating an example of an operation of the user terminal.

FIG. 5 is a diagram illustrating an example of a hardware configuration of the user terminal.

### DESCRIPTION OF EMBODIMENTS

Hereinafter, an embodiment of the present invention will be described in detail with reference to the accompanying drawings. The same or corresponding elements in the description of the drawings are represented by the same reference numerals, and description thereof will not be repeated.

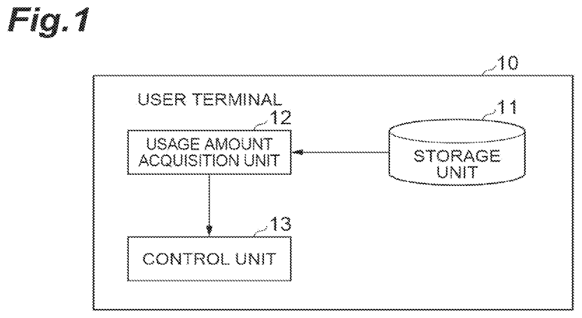

FIG. 1 is a diagram illustrating an example of a functional configuration of a user terminal 10 according to an embodiment. The user terminal 10 is a terminal apparatus that is used (operated) by a user. In the present embodiment, the user terminal 10 includes at least a display (output device 1006) that displays the screen.

An example of the user terminal 10 is a portable terminal such as a mobile phone, a smartphone, or a tablet. However, the user terminal 10 is not limited to the above-described example. For example, the user terminal 10 may be a portable PC such as a laptop PC or may be a stationary PC such as a desktop PC. The user terminal 10 may be a wearable terminal, which is mounted on a part of the body of the user, such as a head-mounted display or a smartwatch.

The user terminal 10 has a function of suppressing long-time use (overuse) of the user terminal 10 by the user. More specifically, the user terminal 10 is configured to reduce the operability of the user terminal 10 when an amount of usage of the user terminal 10 exceeds a predetermined threshold value in a predetermined period. In the present embodiment, as an example, the predetermined period is one day (24 hours of 0:00-24:00). However, the predetermined period is not limited to the above-described example. For example, to suppress the continuous use of the user terminal 10 by the user, the predetermined period may be defined as “a period during which the user continues to continuously use the user terminal 10.”

As illustrated in FIG. 1, the user terminal 10 has a storage unit 11, a usage amount acquisition unit 12, and a control unit 13.

The storage unit 11 stores a usage history (operation history) of the user terminal 10 by the user. For example, in the storage unit 11, information indicating a usage time for which the user uses the user terminal 10 in the predetermined period may be stored. Examples of the usage time of the user terminal 10 include a period during which the screen display of the user terminal 10 is ON, a period during which some user operations on the user terminal 10 continue to be input without an interval of a given period or more, and a period during which a predetermined application is used. In the storage unit 11, information indicating a usage frequency in which the user uses the user terminal 10 in the predetermined period may be stored. Examples of the usage frequency of the user terminal 10 include the number of times a predetermined operation (for example, SNS message posting) is performed, and the number of starts of the application.

The usage amount acquisition unit 12 acquires information indicating an amount of usage of the user terminal 10 by the user in the predetermined period. The amount of usage of the user terminal 10 is, for example, the usage time and the usage frequency of the user terminal 10 described above. The usage amount acquisition unit 12 acquires information (information indicating the usage time or information indicating the usage frequency) stored in the storage unit 11, for example, by accessing the storage unit 11. The usage amount acquisition unit 12 may acquire, for example, the usage time of the user terminal 10 in the predetermined period stored in the storage unit 11 as the amount of usage of the user terminal 10 in the predetermined period. The usage amount acquisition unit 12 may acquire the usage frequency of the user terminal 10 in the predetermined period stored in the storage unit 11 as the amount of usage of the user terminal 10 in the predetermined period. Alternatively, the usage amount acquisition unit 12 may acquire (compute) an index value based on both the usage time and the usage frequency of the user terminal 10 in the predetermined period as the amount of usage of the user terminal 10 in the predetermined period.

Note that the amount of usage of the user terminal 10 is not limited to the above. For example, each weight may be set for each application that operates on the user terminal 10. The usage amount acquisition unit 12 may compute a value obtained by multiplying the amount of usage (for example, the usage time or the usage frequency) of each application by the user in the predetermined period by the weight of each application, as the amount of usage of each application in the predetermined period. The usage amount acquisition unit 12 may acquire (compute) a sum of the amounts of usage of the respective applications in the predetermined period as the amount of usage of the user terminal 10 in the predetermined period.

The control unit 13 reduces the operability of the user terminal 10 when the amount of usage acquired by the usage amount acquisition unit 12 exceeds a predetermined threshold value. Hereinafter, a first example and a second example of operation control for reducing the operability of the user terminal 10 will be described.

### First Example of Operation Control

The control unit 13 reduces the operability of the user terminal 10 by making first scroll operability lower than second scroll operability. The first scroll operability is related to at least one of a scroll width and a scroll speed when a user operation to scroll the screen of the user terminal 10 is performed after the amount of usage exceeds the threshold value. The second scroll operability is related to at least one of a scroll width and a scroll speed when a user operation to scroll the screen of the user terminal 10 is performed before the amount of usage exceeds the threshold value.

When the user terminal 10 is a terminal including a touch panel display such as a smartphone, the user operation to scroll the screen is, for example, an operation to slide a finger in contact with the screen. When the user terminal 10 is a terminal not including a touch panel display such as a desktop PC, the user operation to scroll the screen is, for example, an operation to scroll the screen by a pointing device such as a mouse, a trackpad, or a trackball, or an operation to scroll the screen by pressing direction keys (up and down keys) of a keyboard.

A specific control example will be described in conjunction with a case where the user terminal 10 is a terminal that includes a touch panel display, as an example. As an example, an operation to scroll the screen up and down on a top screen in which icons of a plurality of contents (applications) are arranged in a lattice is focused. For example, it is assumed that the scroll width (second scroll operability) before the amount of usage exceeds the threshold value (during normal) is set in such a manner that “when the finger is scrolled (slid) by 3 cm in an upward direction or a downward direction on the screen, the screen is scrolled by 10 rows in the upward direction or the downward direction.” In this case, the control unit 13 may change the scroll width (first scroll operability) after the amount of usage exceeds the threshold value, for example, in such a manner that “when the finger is scrolled (slid) by 3 cm in the upward direction or the downward direction on the screen, the screen is scrolled by five rows in the upward direction or the downward direction.” In the example, the scroll width after the amount of usage exceeds the threshold value is controlled to be half the scroll width before the amount of usage exceeds the threshold value.

Alternatively, the control unit 13 may change the scroll speed instead of the scroll width. For example, it is assumed that the scroll speed (second scroll operability) before the amount of usage exceeds the threshold value (during normal) is set in such a manner that “when the finger is scrolled (slid) by 3 cm in the upward direction or the downward direction on the screen, the screen is scrolled by 10 rows in the upward direction or the downward direction at the same speed as a speed of the slide operation of the finger.” In this case, the control unit 13 may change the scroll speed (first scroll operability) after the amount of usage exceeds the threshold value, for example, in such a manner that “when the finger is scrolled (slid) by 3 cm in the upward direction or the downward direction on the screen, the screen is scrolled by 10 rows in the upward direction or the downward direction at a speed half a speed of the slide operation of the finger.” In this example, the scroll speed after the amount of usage exceeds the threshold value is controlled to be half the scroll speed before the amount of usage exceeds the threshold value.

Alternatively, the control unit 13 may change both the scroll width and the scroll speed. For example, the control unit 13 may halve both the scroll width and the scroll speed when the amount of usage exceeds the threshold value.

As described above, when the amount of usage exceeds the threshold value, the scroll operability (at least one of the scroll width and the scroll speed) is reduced, such that the operability of the user terminal 10 can be reduced and smooth use of the user terminal 10 can be hindered. As a result, after the amount of usage exceeds the threshold value, the user can be effectively prompted to stop using the user terminal 10, and the long-time use of the user terminal 10 can be effectively suppressed.

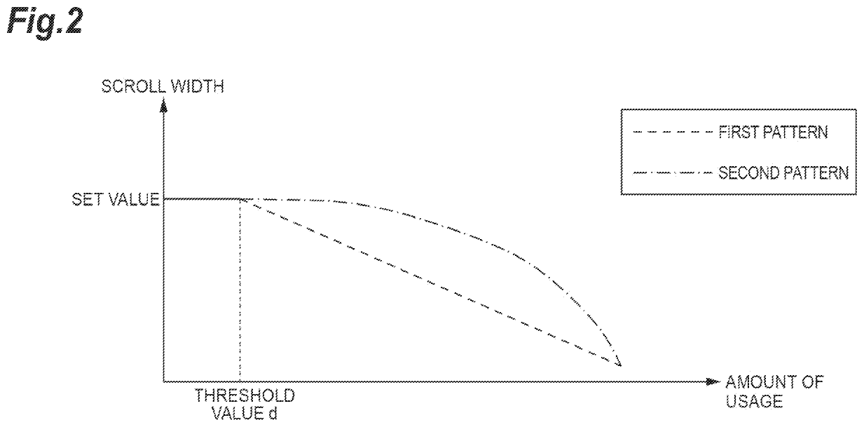

For example, as illustrated in FIG. 2, the control unit 13 may make a degree of reducing the first scroll operability with respect to the second scroll operability greater as a degree of excess of the amount of usage with respect to the threshold value d is greater. For example, as indicated by a first pattern of FIG. 2, the control unit 13 may gradually decrease the scroll width linearly as the degree (that is, “amount of usage-threshold value d”) of excess of the amount of usage with respect to the threshold value d is greater. Alternatively, as indicated by a second pattern of FIG. 2, the control unit 13 may gradually decrease the scroll width nonlinearly as the degree of excess of the amount of usage with respect to the threshold value d is greater. When the scroll width after the amount of usage exceeds the threshold value is represented by W1, the scroll width (that is, a set value) before the amount of usage exceeds the threshold value is represented by W2, and the degree of excess of the amount of usage with respect to the threshold value d is represented by X, the control unit 13 may set W1 based on Expression (1) described below.

$$W 1 = W 2 / ( X + 1 ) \qquad Expression ( 1 )$$

As described above, by increasing the degree of degradation in the scroll operability in proportion to the extent by which the amount of usage exceeds the threshold value d, it is possible to effectively prompt the user who continues to use the user terminal 10 even after the amount of usage exceeds the threshold value to stop using the user terminal 10.

### Second Example of Operation Control

The control unit 13 reduces the operability of the user terminal 10 by making a first period longer than a second period. The first period is from when a user operation to instruct execution of predetermined processing is performed after the amount of usage exceeds the threshold value to when the predetermined processing is executed. The second period is from when the user operation to instruct the execution of the predetermined processing is performed before the amount of usage exceeds the threshold value to when the predetermined processing is executed.

Examples of the predetermined example include processing of starting, after an operation to select (tap) an icon of a content displayed on the screen, the content corresponding to the icon, processing of reflecting characters input on the screen when a character input operation by the user is made, and processing of displaying, when a link to another Web page is clicked during Web page browsing by a browser, information of another Web page on the screen. That is, in the second example of the operation control, the control unit 13 reduces a response speed (response time) from when a user operation is performed to when the corresponding predetermined processing is executed (reflected), making it slower than a response speed before the amount of usage exceeds the threshold value.

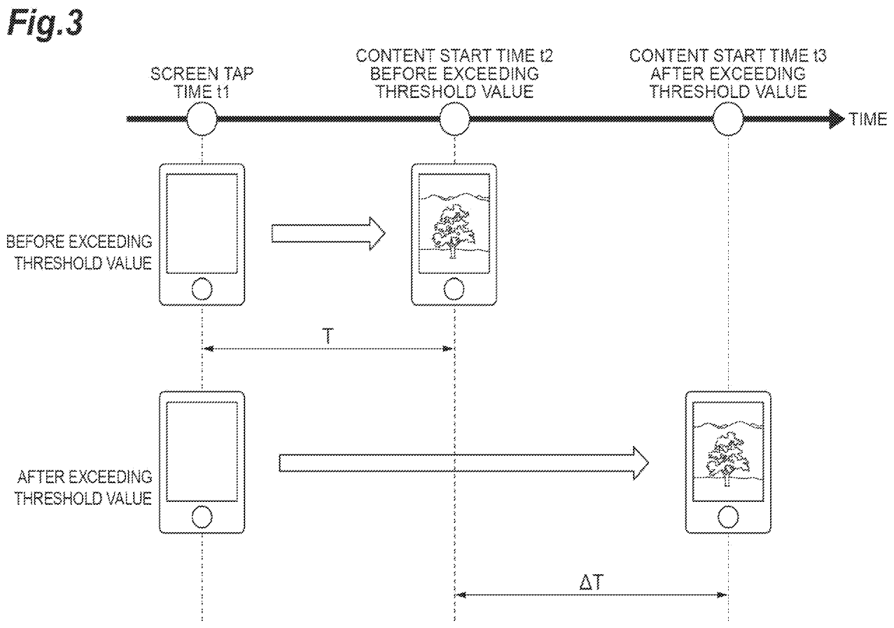

For example, as illustrated in FIG. 3, the control unit 13 may differ a time from when an icon of a content displayed on the screen of the user terminal 10 is tapped to when the start of the content is completed, before and after the amount of usage exceeds the threshold value. In the example of FIG. 3, before the amount of usage exceeds the threshold value, the start of the content is completed at time t2 when a period T (second period) elapses from time t1 at which the icon of the content is tapped. On the other hand, after the amount of usage exceeds the threshold value, the control unit 13 intentionally slows down a time from when the content is selected to when the start of the content is completed, by a period ΔT. As a result, after the amount of usage exceeds the threshold value, the start of the content is completed at time t3 when a period T+ΔT (first period) elapses from time t1 at which the icon of the content is tapped.

As described above, when the amount of usage exceeds the threshold value, a response speed (response time) of predetermined processing (in the above-described example, start processing of a content) is reduced, so that the operability of the user terminal 10 can be reduced and the smooth use of the user terminal 10 can be hindered. As a result, after the amount of usage exceeds the threshold value, the user can be effectively prompted to stop using the user terminal 10, and the long-time use of the user terminal 10 can be effectively suppressed.

The control unit 13 may make a degree of extending the first period (in the example of FIG. 3, “T+ΔT”) with respect to the second period (in the example of FIG. 3, “T”) greater as the degree (that is, “amount of usage-threshold value”) of excess of the amount of usage with respect to the threshold value is greater. For example, the control unit 13 may make ΔT as a penalty period when the amount of usage exceeds the threshold value, gradually greater as the degree of excess of the amount of usage with respect to the threshold value is greater. For example, the control unit 13 may determine Δt based on Expression (2) described below. In Expression (2) described below, “X” represents the degree of excess of the amount of usage with respect to the threshold value, and “a” and “k” represent freely selected positive numbers.

$$Δ T = aX + k \qquad Expression ( 2 )$$

As described above, by increasing the degree of degradation in the response performance of predetermined processing in proportion to the extent by which the amount of usage exceeds the threshold value, it is possible to effectively prompt the user who continues to use the user terminal 10 even after the amount of usage exceeds the threshold value to stop using the user terminal 10.

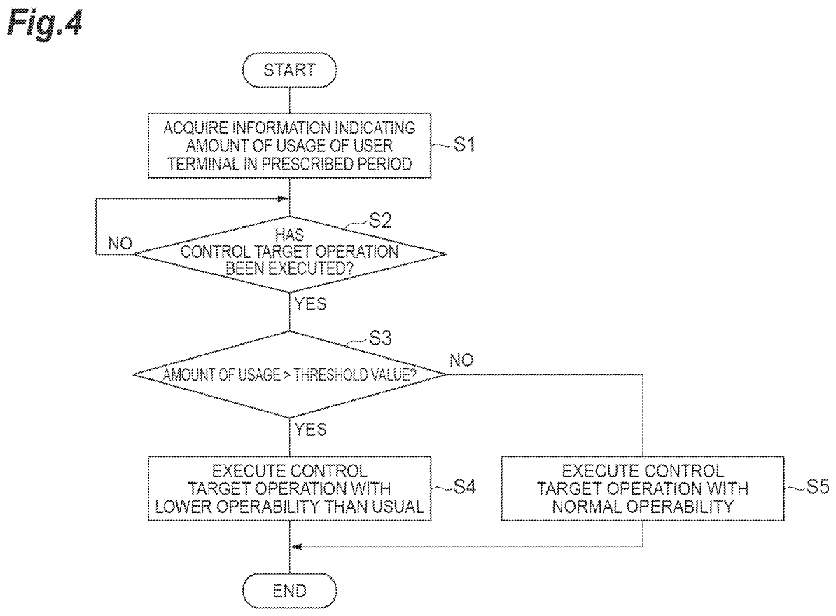

Next, an example (including an information processing method according to the embodiment) of an operation of the user terminal 10 will be described with reference to FIG. 4.

In Step S1, the usage amount acquisition unit 12 acquires information (for example, the usage time or the usage frequency) indicating the amount of usage of the user terminal 10 by the user in the predetermined period, for example, by accessing the storage unit 11.

In Step S2, the control unit 13 determines whether or not a user operation (for example, a scroll operation or an operation to select an icon of a content to start the content) to be controlled is executed. When the user operation to be controlled is executed (Step S2: YES), the control unit 13 proceeds to processing of Step S3. On the other hand, when the user operation to be controlled is not executed (Step S2: NO), the processing of Step S3 is not executed until the user operation to be controlled is executed.

In Step S3, the control unit 13 determines whether or not the amount of usage exceeds the threshold value. When the amount of usage exceeds the threshold value (Step S3: YES), the control unit 13 executes processing of Step S4. On the other hand, when the amount of usage does not exceed the threshold value (Step S3: NO), the control unit 13 executes processing of Step S5.

In Step S4, the control unit 13 executes the operation to be controlled with operability lower than normal. For example, when the scroll operation to scroll the screen is executed as the operation to be controlled, the control unit 13 may execute the first example of the operation control described above. That is, the control unit 13 may reduce the scroll operability (at least one of the scroll width and the scroll speed) with respect to the scroll operability before the amount of usage exceeds the threshold value. When the operation to select an icon of a content to start the content is executed as the operation to be controlled, the control unit 13 may execute the second example of the operation control described above. That is, the control unit 13 may extend a start time from when an icon of a content is selected to when the start of the content is completed, with respect to a start time before the amount of usage exceeds the threshold value.

In Step S5, the control unit 13 executes the operation to be controlled with normal operability. That is, the control unit 13 executes the operation to be controlled without executing control for intentionally reducing operability like Step S4.

In the user terminal 10 described above, the operability of the user terminal 10 is controlled to be reduced when the amount of usage of the user terminal 10 exceeds the threshold value. In this way, the user-friendliness of the user terminal 10 is intentionally reduced as a penalty for the amount of usage beyond the threshold value, so that the user can be prompted to stop using the user terminal 10. On the other hand, even after the amount of usage exceeds the threshold value, the operability of the user terminal 10 is reduced, but the use of the user terminal 10 itself is not forcibly prohibited. Therefore, when the user is under special situation in which the user has to use the user terminal 10 even after the amount of usage exceeds the threshold value, the user can continue to use the user terminal 10. In this way, with the user terminal 10, it is possible to effectively suppress the long-time use of the user terminal 10 without greatly obstructing user's work.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

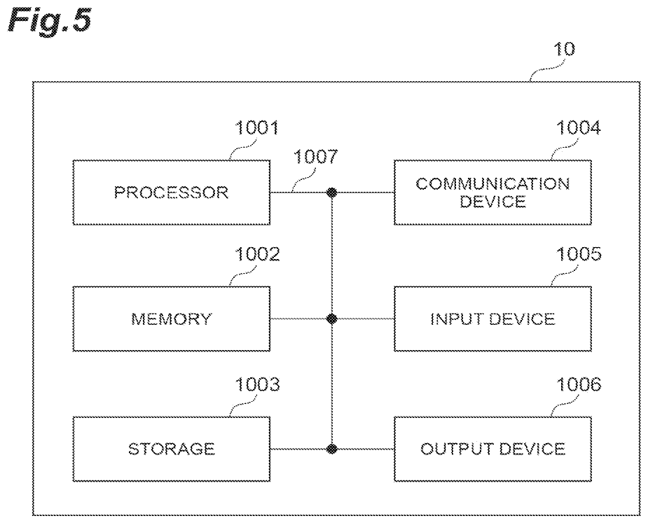

For example, the user terminal 10 according to an embodiment of the present invention may function as a computer that performs information processing method of the present disclosure. FIG. 5 is a diagram illustrating an example of a hardware configuration of the user terminal 10 according to the embodiment of the present disclosure. The user terminal 10 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the user terminal 10 may include one or a plurality of devices illustrated in FIG. 5, or may be configured without including some of the devices.

Each function in the user terminal 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, each functional unit (e.g., the control unit 13) of the user terminal 10 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the information processing method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the user terminal 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on (on the basis of)” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as “a”, “an”, and “the” in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

10 User terminal
11 Storage unit
12 Usage amount acquisition unit
13 Control unit

1. A user terminal that is operated by a user, the user terminal comprising:
a usage amount acquisition unit configured to acquire information indicating an amount of usage of the user terminal by the user in a predetermined period; and
a control unit configured to reduce operability of the user terminal when the amount of usage exceeds a predetermined threshold value.

2. The user terminal according to claim 1,
wherein the control unit is configured to reduce the operability of the user terminal by making first scroll operability lower than second scroll operability, wherein the first scroll operability is related to at least one of a scroll width and a scroll speed when a user operation to scroll a screen of the user terminal is performed after the amount of usage exceeds the threshold value, and the second scroll operability is related to at least one of a scroll width and a scroll speed when the user operation to scroll the screen is performed before the amount of usage exceeds the threshold value.

3. The user terminal according to claim 2,
wherein the control unit is configured to make a degree of reducing the first scroll operability with respect to the second scroll operability greater as a degree of excess of the amount of usage with respect to the threshold value is greater.

4. The user terminal according to claim 1,
wherein the control unit is configured to reduce the operability of the user terminal by making a first period longer than a second period, wherein the first period is from when a user operation to instruct execution of predetermined processing is performed after the amount of usage exceeds the threshold value to when the predetermined processing is executed, and the second period is from when the user operation to instruct the execution of the predetermined processing is performed before the amount of usage exceeds the threshold value to when the predetermined processing is executed.

5. The user terminal according to claim 4,
wherein the control unit is configured to make a degree of extending the first period with respect to the second period greater when a degree of excess of the amount of usage with respect to the threshold value is greater.
